(19) United States
(12) Patent Application Publication
(10) Pub. No.: US 2014/0071540 A1
(43) Pub. Date: Mar. 13, 2014

(54) OPTICAL SPLITTING DEVICE

(71) Applicant: DELTA ELECTRONICS, INC., Taoyuan-Hsien (TW)

(72) Inventors: Yu-Hsien LIAO, TAOYUAN HSIEN (TW); Ming-Yi HUANG, TAOYUAN HSIEN (TW); Te-Hsuan YANG, TAOYUAN HSIEN (TW)

(73) Assignee: DELTA ELECTRONICS, INC., TAOYUAN HSIEN (TW)

(21) Appl. No.: 13/775,266

(22) Filed: Feb. 25, 2013

(30) Foreign Application Priority Data
Sep. 12, 2012 (TW) 101133229

(51) Int. Cl. G02B 27/10

(52) U.S. Cl. CPC G02B 27/108
USPC 359/636

(57) ABSTRACT

An optical splitting device includes a body and an optical condensing member. The optical condensing member is disposed on the body, and includes a first light incident surface and a second light incident surface. The second light incident surface is discontinuously adjacent to the first light incident surface.

### RELATED APPLICATIONS

This application claims priority to Taiwan Application Serial Number 101133229, filed Sep. 12, 2012, which is herein incorporated by reference.

### BACKGROUND

1. Technical Field

Embodiments of the present invention relate to an optical device. More particularly, embodiments of the present invention relate to an optical splitting device.

2. Description of Related Art

With the advance of computer and networking technologies, people in the modern life can easily get or share information via the Internet, which makes the life more convenient than ever. In this regard, the Internet is an indispensable technology nowadays.

To provide services with higher speed of data transmission, demands on boarder bandwidth of the Internet keep increasing. An optical fiber, because of its advantages such as capability of fast data transmission, has therefore been widely used in communications to expand the bandwidth of the Internet.

In the fiber-optic communications, a light source is employed to provide a light beam to an optical coupling device, and then the optical coupling device directs the light beam to the optical fiber by reflection or refraction, so as to propagate the light beam in the optical fiber.

Because the luminance of the light source may change with the ambience, e.g., surrounding temperature, the light flux received by the optical fiber is unstable, which deteriorates the stability of the data transmission therethrough.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

An optical splitting device is provided for separating the original light beam emitted from the light source as two separated light beams, in which one light beam is directed to the optical fiber and another light beam is directed to a photodiode. Therefore, the user can utilize the photodiode to monitor whether the light flux of light source is stable based on the light beam received by the photodiode.

In accordance with one embodiment of the present invention, the optical splitting device includes a body and an optical condensing member. The optical condensing member is disposed on the body, and includes a first light incident surface and a second light incident surface. The second light incident surface is discontinuously adjacent to the first light incident surface.

In accordance with another embodiment of the present invention, the optical splitting device includes a body, an optical condensing member and an optical splitting member. The optical condensing member is disposed on one side of the body; and the optical splitting member is disposed on another side of the body opposite to the optical condensing member. The optical splitting member is configured to separate a light beam from the optical condensing member as a first secondary light beam and a second secondary light beam. The intensity of the first secondary light beam is not equal to the intensity of the second secondary light beam. The first secondary light beam is different from the second secondary light beam in direction.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a cross-sectional view of an optical splitting device in accordance with one embodiment of the present invention;

FIG. 2 is an optical path diagram in accordance with one example of the optical splitting device of FIG. 1;

FIG. 3 is a top view of the optical splitting device of FIG. 1;

FIG. 4 is a cross-sectional view of the optical device in accordance with one example of the present invention;

FIG. 5 is a cross-sectional view of the optical splitting device in accordance with another example of the present invention;

FIG. 6 is a cross-sectional view of the light splitting device in accordance with yet another example of the present invention;

FIG. 7 is an optical path diagram of the optical splitting device in accordance with another embodiment of the present invention; and

FIG. 8 is an optical path diagram of the optical splitting device in accordance with yet another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

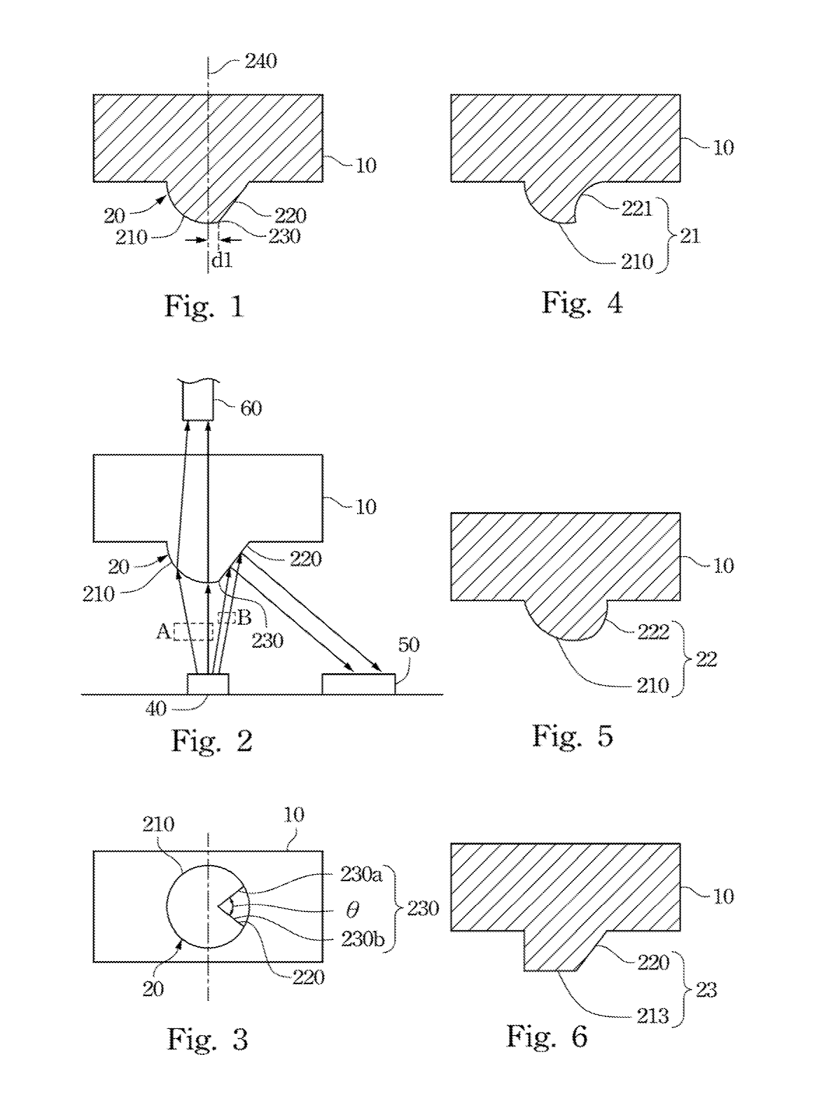

FIG. 1 is a cross-sectional view of an optical splitting device in accordance with one embodiment of the present invention. As shown in this figure, the optical splitting device includes a body 10 and an optical condensing member 20. The optical condensing member 20 is positioned on the body 10. The optical condensing member 20 includes a first light incident surface 210 and a second light incident surface 220. The second light incident surface 220 is discontinuously connected to the first light incident surface 210.

It is noted that “discontinuously connected” in this disclosure refers that two adjacent elements have different slope or curvature and are jointed by a turning part. For example, the optical condensing member 20 may include a light incident turning part 230. The light incident turning part 230 connects the first light incident surface 210 and the second light incident surface 220. The light incident turning part 230 is formed by the difference between the slopes or curvatures of the first light incident surface 210 and the second light incident surface 220.

FIG. 2 is an optical path diagram in accordance with one example of the optical splitting device of FIG. 1. As shown in FIG. 2, when a light source 40 emits a light beam A and a light beam B toward the optical condensing member 20, the light beam A can be directed by the first light incident surface 210 to propagate along a first direction to the optical fiber 60, and the light beam B can be directed by the second light incident surface 220 to propagate along a second direction to the photodiode 50.

In some embodiments, the first light incident surface 210 is greater than the second light incident surface 220. Specifically, the area of the first light incident surface 210 is greater than the area of the second light incident surface 220. Therefore, the light flux of the light beam A passing through the first light incident surface 210 is higher than the light flux of the light beam B passing through the second light incident surface 220, so that not only the optical fiber 60 can receive enough optical energy, but also the photodiode 50 can monitor whether the light flux of the light source 40 is stable or not.

Referring FIG. 1, the optical condensing member 20 includes a centerline 240 as an axis. In some embodiments, the centerline 240 does not cross to the second light incident surface 220. The area of the first light incident surface 210 is greater than the area of the second light incident surface 220, and therefore, the light flux passing through the first light incident surface 210 is higher than the light flux passing through the second light incident surface 220.

Referring FIG. 1 and FIG. 2, in some embodiments, the position of the light incident turning part 230 closest to the centerline 240 defines an interval d1 spaced from the centerline 240. By increasing the interval d1, the area of the first light incident surface 210 increases, and the area of the second light incident surface 220 decreases. Therefore, the light flux of the light beam A passing through the first light incident surface 210 increases and the light flux of the light beam B passing through the second light incident surface 220 decreases, so that the energy received by the optical fiber 60 can be increased.

FIG. 3 is a top view of the optical splitting device of FIG. 1. As shown in FIG. 3, a first light incident turning part 230a and a second light incident turning part 230b are formed between the first light incident surface 210 and the second light incident surface 220. The first light incident turning part 230a and the second light incident turning part 230b cooperate to form the light incident turning part 230. An angle θ is included between the first light incident turning part 230a and the second light incident turning part 230b. In some embodiments, the angle θ ranges from about 1-359 degrees. Preferably, the angle θ ranges from about 1-180 degrees. More Preferably, the angle θ ranges from about 1-90 degrees.

In some embodiments, the first light incident surface 210 is a planar surface or a curved surface, and the second light incident surface 220 is also a planar surface or a curved surface. By combining various-shaped first light incident surfaces 210 (such as the planar surface or the curved surface) and various-shaped second light incident surfaces 220 (such as the planar surface or the curved surface), various optical splitting devices can be provided as shown in the following examples.

FIG. 4 is a cross-sectional view of the optical device in accordance with one example of the present invention. This example is similar to which is shown in FIG. 1, and the main difference is that the second light incident surface 221 is a curved surface in this embodiment, while the second light incident surface 220 in FIG. 1 is a planar surface. The second light incident surface 221 is caved inwards the optical condensing member 21 so that the light flux can be monitored more accurately.

FIG. 5 is a cross-sectional view of the optical splitting device in accordance with another example of the present invention. This example is similar to which is shown in FIG. 4, and the main difference is that the second light incident surface 222 is a curved surface protruded outwards the optical condensing member 22. The curvature of the first light incident surface 210 and the curvature of the second light incident surface 222 are not equal. The second light incident surface 222 can also improve the accuracy of monitoring the light flux.

FIG. 6 is a cross-sectional view of the light splitting device in accordance with yet another example of the present invention. This example is similar to which is shown in FIG. 1, and the main difference is that the optical condensing member 23 in this example is protruded on the body 10 and includes the first light incident surface 213 and the second light incident surface 220. The first light incident surface 213 is a planar surface, so that it can maximize the energy received from parallel light beams. Further, the second light incident surface 220 can be the planar surface, the concave curved surface, the protruded curved surface, and so on, depending on requests.

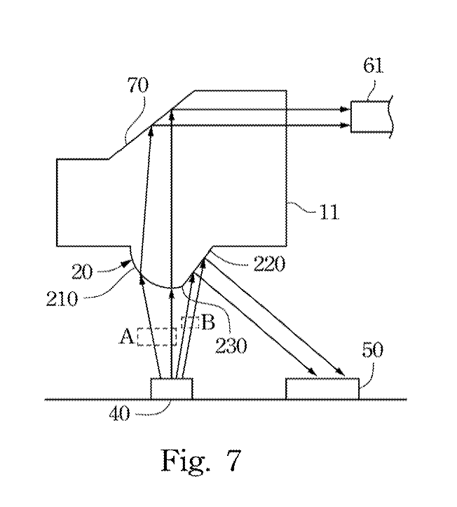

FIG. 7 is an optical path diagram of the optical splitting device in accordance with another embodiment of the present invention. The main difference between this embodiment and FIG. 2 is that the optical splitting device further includes an optical path modifier 70. The optical path modifier 70 is positioned on the side of the body 11 opposite to the optical condensing member 20. When the optical fiber 61 is not placed on the focal point of the optical condensing member 210, the optical path modifier 70 can modify the direction of the light beam A passing through the first light incident surface 210, so that the light beam A can still be received by the optical fiber 61.

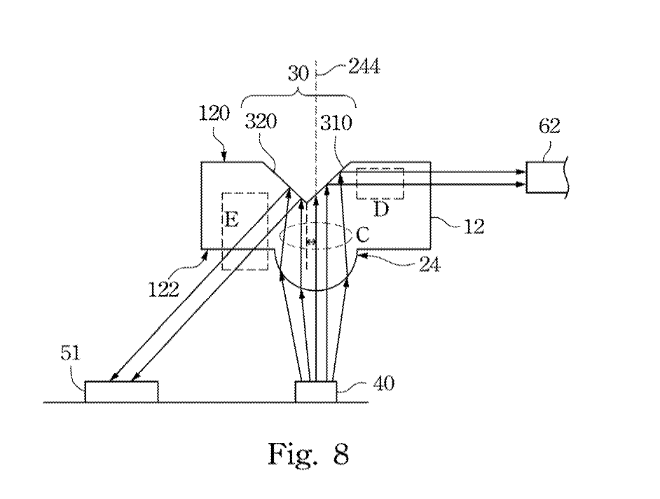

FIG. 8 is an optical path diagram of the optical splitting device in accordance with yet another embodiment of the present invention. As shown in FIG. 8, the optical splitting device includes a body 12, an optical condensing member 24 and an optical splitting member 30. The optical condensing member 24 is positioned on one side of the body 12. The optical splitting member 30 is positioned on another side of the body 12 opposite to the optical condensing member 24. The optical splitting member 30 is used to separate a light beam C from the optical condensing member 24 as a first secondary light beam D and a second secondary light beam E propagating along directions different from each other. The light intensity of the first secondary light beam D is not equal to the light intensity of the second secondary light beam E. The direction of the first secondary light beam D is different from the direction of the second secondary light beam E. That is, the first secondary light beam D and the second secondary light beam E are directed toward different directions.

The optical splitting member 30 includes a first optical splitting surface 310 and a second optical splitting surface 320. The first optical splitting surface 310 is used to reflect the first secondary light beam D, and thereby to direct it propagating along a first direction. The second optical splitting surface 320 is connected to the first optical splitting surface 310, and it is used to reflect the second secondary light beam E, and thereby to direct it propagating a second direction. The centerline 244 of the optical condensing member 24 does not cross to the second optical splitting surface 320. In some embodiments, the first direction that the first secondary light beam D propagates is toward the optical fiber 62, and the second direction that the second secondary light beam E propagates is toward the photodiode 51. The light intensity of the first secondary light beam D is higher than the light intensity of the second secondary light beam E.

The body 12 includes an upper surface 120. The first optical splitting surface 310 and the second optical splitting surface 320 are cut on the upper surface 120 of the body 12 inwards.

In this embodiment, the light intensity of the first secondary light beam D reflected by the first optical splitting surface 310 is higher than the light intensity of the second secondary light beam E reflected by the second optical splitting surface 320, and therefore, not only the optical fiber 62 can receive enough optical energy, but also the photodiode 51 can effectively monitor whether the light source 40 stably illuminates or not. In some embodiments, the first optical splitting surface 310 is not continuously connected to the second optical splitting surface 320 for separating light beams.

Further, the optical condensing member 24 can also be a continuous curved surface, and can also be various shapes as described in the foregoing examples. Additionally, the first optical splitting surface 310 and the second optical splitting surface 320 can also be curved or polygonal.

It is noted that the terms “upper” or “lower” is only used to assist the reader understanding the correlation between elements. For example, the body 12 includes the lower surface 122 and the upper surface 120, but the lower surface 122 is not necessarily under the upper surface 120. As long as the body 12 has two opposite surfaces, those surfaces can meet the definitions of the lower surface 122 and the upper surface 120.

Further, although the aforementioned embodiments and examples are described to separate the light beam emitted from the light source 40 toward different directions, and nevertheless, the scope of this invention is not only limited to those embodiments and examples. The light source 40 can also be replaced by a light receiving device depending on requests, and the light receiving device can be used to monitor whether the optical energy transmitted in the optical fiber 60 is stable or not when receiving enough energy from the optical fiber 60.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical splitting device, comprising:
a body; and
an optical condensing member disposed on the body, the optical condensing member comprising:
a first light incident surface; and
a second light incident surface discontinuously adjacent to the first light incident surface.

2. The optical splitting device of claim 1, wherein the first light incident surface is greater than the second light incident surface in area.

3. The optical splitting device of claim 1, wherein the centerline of the optical condensing member does not intersect with the second light incident surface.

4. The optical splitting device of claim 1, wherein the first light incident surface is a planar surface or a curved surface.

5. The optical splitting device of claim 1, wherein the second light incident surface is a planar surface or a curved surface.

6. The optical splitting device of claim 1, further comprising:
an optical splitting member disposed on the body and opposite to the optical condensing member, configured to separate a light beam from the optical condensing member as two secondary light beams, wherein the respective secondary light beams are directed toward different directions.

7. An optical splitting device, comprising:
a body;
an optical condensing member disposed on one side of the body; and
an optical splitting member positioned on another side of the body opposite to the optical condensing member, wherein the optical splitting member is configured to separate a light beam from the optical condensing member as a first secondary light beam and a second secondary light beam, wherein the intensity of the first secondary light beam is not equal to the intensity of the second secondary light beam, wherein the first secondary light beam is different from the second secondary light beam in direction.

8. The optical splitting device of claim 7, wherein the optical splitting member comprises:
a first optical splitting surface for directing the first secondary light beam to propagate along a first direction;
a second optical splitting surface connected to the first optical splitting for directing the second secondary light beam to propagate along a second direction, wherein the centerline of the optical condensing member does not cross to the second optical splitting surface.

9. The optical splitting device of claim 8, wherein the first optical splitting surface is a planar surface or a curved surface.

10. The optical splitting device of claim 8, wherein the second optical splitting surface is a planar surface or a curved surface.
